(19) United States
(12) Patent Application Publication
(10) Pub. No.: US 2010/0295548 A1
(43) Pub. Date: Nov. 25, 2010

(54) METHODS AND APPARATUS FOR PROVIDING COMPLIMENTARY RESISTIVITY AND STANDOFF IMAGE

(75) Inventors: Daniel T. Georgi, Houston, TX (US); Gregory B. Itskovich, Houston, TX (US); Alexandre N. Bespalov, Spring, TX (US); Michael B. Rabinovich, Houston, TX (US); Billy Harold Corley, Conroe, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/784,084

(22) Filed: May 20, 2010

Related U.S. Application Data
(60) Provisional application No. 61/179,998, filed on May 20, 2009.
(60) Provisional application No. 61/235,843, filed on Aug. 21, 2009.

(51) Int. Cl. G01V 3/02

(52) U.S. Cl. 324/355

(57) ABSTRACT

A method for presenting a formation property to a user includes estimating an initial property of the formation using a tool conveyed in a borehole and estimating a relationship between the tool and the formation based on information received from the tool. The method also includes presenting the user a first output based at least in part on the initial property and presenting a second output based at least in part on the relationship proximate the first output.

### CROSS-REFERENCE TO RELATED APPLICATIONS AND PRIORITY CLAIM

This application claims the benefit of U.S. Provisional Application Ser. No. 61/179,998, entitled “METHODS AND APPARATUS FOR PROVIDING COMPLIMENTARY RESISTIVITY AND STANDOFF IMAGE”, filed May 20, 2009, and U.S. Provisional Patent Application Ser. No. 61/235,843, entitled “METHODS AND APPARATUS FOR PROVIDING COMPLIMENTARY RESISTIVITY AND STANDOFF IMAGE”, filed Aug. 21, 2009, under 35 U.S.C. §119(e), both which is incorporated herein by reference in their entirety.

### BACKGROUND

The teachings herein relate to imaging sub-surface materials and geologic formations, and in particular, to systems and methods for providing formation resistivity image.

In underground drilling applications, such as oil and gas exploration and recovery, a borehole is drilled into the earth. As a part of the drilling process, drilling mud is typically introduced into the borehole. While drilling mud prevents rapid depressurization (i.e., a “blowout”) and is therefore beneficial, use of drilling mud can complicate measurements taken to ascertain exploration information.

One type of drilling mud is referred to as “oil-based” mud, while another is “water-based” mud. Other fluids found in the borehole include, for example, formation fluids such as oil, gas, water, salted water as well as various combinations of these and other fluids. Separating an influence of the drilling mud on measurements of these other fluids can be a complicated task, and make imaging of the surrounding volume difficult. High resistivity of the “oil-based” mud complicates evaluation of formation properties since it makes difficult to penetrate current into the formation.

One technique for studying downhole formations is resistivity imaging. Many factors can affect the resolution of the resistivity imaging instruments. For example, tool standoff (i.e., the gap between the surface of the sensor and the wall of the borehole), variability of the standoff, and variability of the electrical properties of the drilling mud as well as the formation properties can all affect resolution of the resistivity imaging instrument.

One particular challenging situation for imaging low resistivity formations, such as in the Gulf of Mexico, arises in the wells where the oil-based mud has been used as a drilling fluid The total impedance, measured by a resistivity imaging instrument, primarily includes three sequentially connected impedances formed respectively by the formation, the drilling fluid, and the instrument measurement circuit itself Typically, impedance of the instrument measurement circuit has been known and small compared to those of the formation and drilling fluid, and, therefore, could be easy accounted for or often neglected. Accordingly, sensitivity of the instrument to the changes in resistivity of the formation deteriorates as a contribution of the formation into the overall impedance goes down.

What are needed are techniques for enhancing resistivity images taken downhole. Preferably, the techniques providing improved image quality in the conditions of oil-based mud and low resistivity formations.

### SUMMARY

In one embodiment, the a method for presenting a formation property is disclosed. The method of this embodiment includes estimating an initial property of the formation using a tool conveyed in a borehole; estimating a relationship between the tool and the formation based on information received from the tool; presenting the user a first output based at least in part on the initial property; and presenting a second output based at least in part on the relationship proximate the first output.

In another embodiment, a computer program product for presenting two or more images of sub-surface materials is disclosed. The computer program product of this embodiment includes a storage medium readable by a processing circuit and storing instructions for execution by the processing circuit for facilitating a method including: estimating an initial property of the formation using a tool conveyed in a borehole; estimating a relationship between the tool and the formation based on information received from the tool; presenting the user a first output based at least in part on the initial property; and presenting a second output based at least in part on the relationship proximate the first output.

In yet another embodiment, a system for presenting a formation property to a user is disclosed. The system of this embodiment includes a processor that receives information from a tool conveyed in a borehole proximate the earth formation, the processor estimating an initial property of the formation and estimating a relationship between the tool and the formation based on information received from the tool. The system of this embodiment also includes a graphical user interface in cooperation with the processor that displays a first output based on the initial property and a second output based on the relationship, the second output being displayed proximate the first output.

In yet another embodiment, a method for presenting a formation property to a user is disclosed. The method of this embodiment includes estimating an initial property of the formation using a tool conveyed in a borehole; estimating a relationship between the tool and the formation based on information received from the tool; and presenting the user a first output based on the initial property and the relationship, the portion of the first output based on the initial property being muted when the relationship exceeds a preset amount.

### BRIEF DESCRIPTION OF THE DRAWINGS

Referring now to the drawings wherein like elements are numbered alike in the several Figures:

FIG. 1 illustrates an exemplary imaging instrument suspended in a borehole in accordance with exemplary embodiments;

FIG. 2 illustrates an example of a processing system on which various a aspects of present invention may be implemented;

FIG. 3 is a flow chart providing an exemplary method;

FIG. 4 illustrates a partial top down view of a pad having offset electrodes;

FIG. 5 illustrates an exemplary equivalent schematic circuit diagram of a sensor electrode;

FIG. 6 illustrates an exemplary method for impedance measurement and calculation implementing dual stand off arrangements;

FIG. 7 is an illustration of a resistivity image in combination with a standoff image according to the teachings herein.

### DETAILED DESCRIPTION

Disclosed herein are methods and apparatus for providing comparative images of a formation. In general, the images are presented in proximity to each other, such that evaluation of the formation is facilitated. In general, the presentation provides enhanced knowledge of the character of the formation by providing users with quality control information derived from resistivity images.

In general, the methods and apparatus call for deriving an imaginary part of the impedance for resistivity measurements and then deriving standoff values. The standoff values may be derived through a priori knowledge of a dielectric constant for drilling mud, or by performing measurements downhole and estimating the dielectric constant from the measurements.

An exemplary instrument for making resistivity measurements is available from Baker Hughes, Incorporated of Houston, Tex. The instrument, referred to as an “Earth Imager,” has provided for a variety of resistivity images.

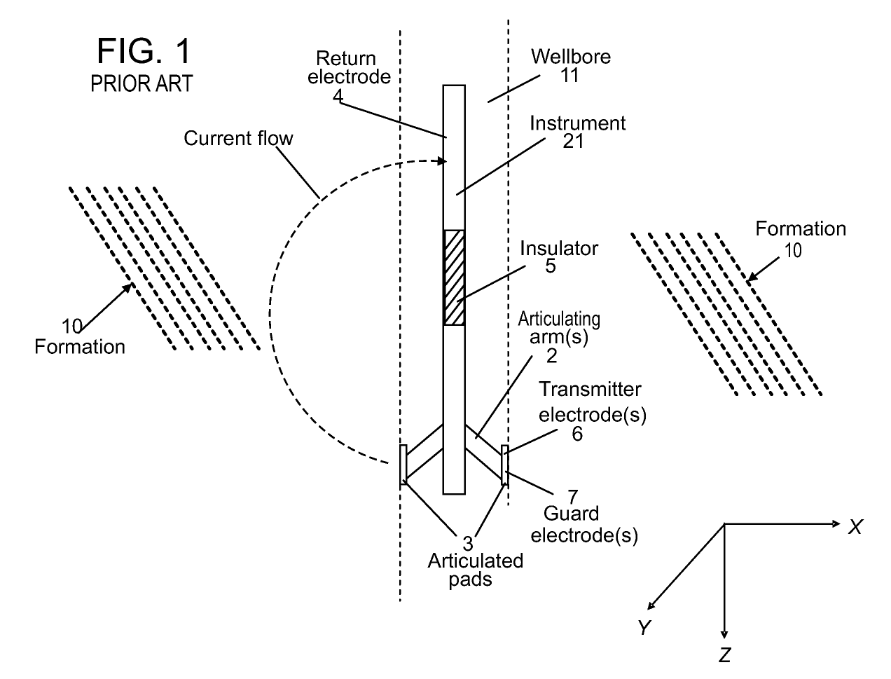

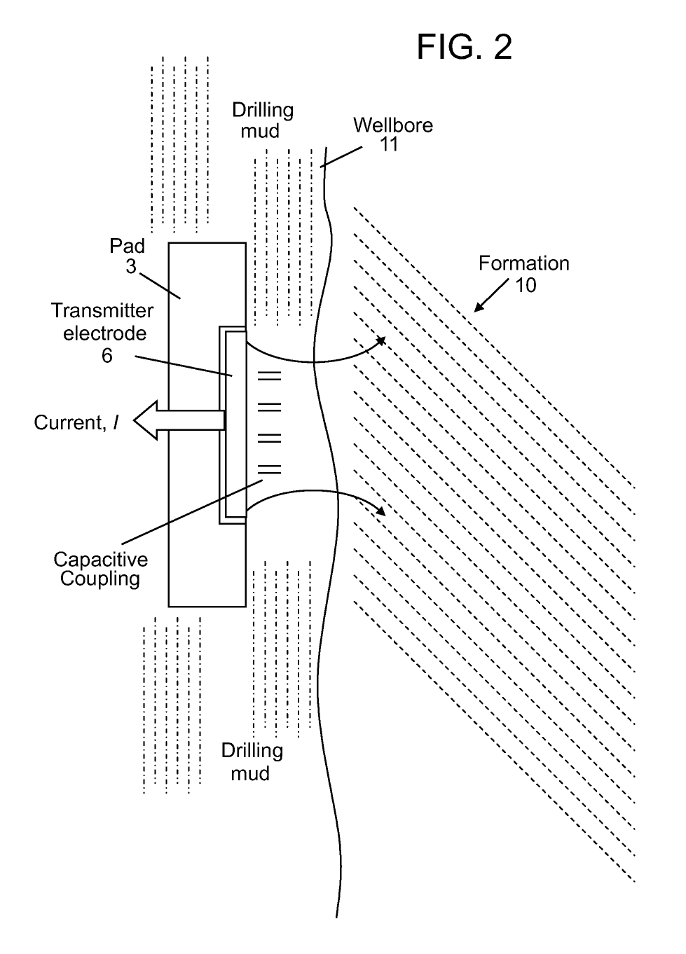

With regard to the exemplary instrument, reference may be had to FIG. 1. In FIG. 1, there is shown a depiction of a prior art instrument 21 for performing resistivity imaging. In this example, the instrument 21 is disposed within a wellbore 11 (also referred to as a “borehole”) that traverses underground formations 10. The instrument 21 includes pads 3 mounted on articulating arms 2. In operation, the articulated pads 3 are typically pressed up against a wall of the wellbore 11 and make firm contact therewith. Current, I, flows from at least one transmitter electrode 6 on the pad 3 to at least one return electrode 4. The return electrode 4 is electrically separated from each transmitter electrode 6 by an insulator 5. The current, I, is typically alternating current (AC).

In some other embodiments, at least one return electrode 4 and at least one transmitter electrode 6 are co-located on the pad 3. Of course, a variety of other electrode arrangements may be realized. For example, at least some of the electrodes may be large, small, concentric, opposing, aligned, parallel, orthogonal or described by other such terms. Generally, the at least one return electrode 4 and the at least one transmitter electrode 6 (and, in some instances, the supporting equipment necessary operation thereof) are referred to as a “sensor.”

Additional aspects of well logging equipment support deployment of the instrument 21, and are generally known in the art and therefore not shown. For example, drilling mud may be pumped into the wellbore 11 from a pit, using various pumping components, and is often circulated from the wellbore 11 back to the pit. Generally, the wellbore 11 is at least partially filled with a mixture of fluids including water, drilling mud, oil and formation fluids that are indigenous to the formations 10 penetrated by the wellbore 11 (also referred to as a “borehole”).

The instrument 21 is generally suspended in the wellbore 11 at the bottom end of a wireline. The wireline is often carried over a pulley supported by a derrick. Wireline deployment and retrieval is typically performed by a powered winch carried by a service truck or skid. Aside from deployment by the service truck or the skid, the instrument 21 may be deployed using any other technique that is deemed suitable.

For purposes of the discussion herein, the imaging instrument 21 is used during wireline logging (that is, after drilling), and is deployed by wireline as part of a downhole tool. However, one skilled in the art will recognize that this is illustrative and not limiting of the teachings herein. For example, aside from wireline deployment, the instrument 21 may be deployed using coil tubing, a pipe, a drill string, a tractor, or any other technique that is deemed suitable.

As is known in the art, the instrument 21 or some external component, such as the service truck, include electronics and support equipment to operate the instrument 21. Included with the electronics and support equipment is a power supply for providing power to the instrument 21, processing capabilities, data storage, memory and other such components as needed. The power provided to the instrument 21 may be delivered over a broad range of frequencies, f, and currents, I. Signal analysis may include known techniques for analog signal processing and digital signal processing as appropriate.

In some embodiments, the power supply for the sensor provides alternating current (AC) that is in a relatively high frequency, f, range (for example, of about 1 MHz to about 10 MHz). However, the sensor may be operated at frequencies above or below this range, and alternatively, the sensor may be used with direct current (DC) if desired.

For convention, certain definitions are provided. As discussed herein, the term “formation” and other similar terms generally refer to sub-surface materials that are located within a survey volume, which generally surrounds a wellbore (or “borehole”). That is, a “formation” is not limited to geologic formations as conventionally considered, and may generally include any materials of interest found downhole. As used herein, the term “real-time” generally refers to a temporal context that is frequent enough for users to make meaningful decisions such as operational decisions where logging routines may be adjusted according to data provided. The terms used herein are adopted for convention and purposes of illustration and are not to be construed as limiting of the invention.

It should be recognized that by using alternating current (AC), that the terminology “transmitter” and “return” with regard to the electrodes generally relate to operation of a sensor at some instant in time.

By convention, “vertical” generally refers to a z-direction (along the axis of the borehole 12) and “horizontal” refers to a plane perpendicular to the vertical. The horizontal includes an x-direction and a y-direction. For convenience and perspective, this convention is generally carried throughout the figures provided herein.

As discussed herein, oil-based mud is generally regarded as being “non-conductive.” However, it is recognized that oil-based mud and the variations of drilling mud as may be useful for practice of the teachings herein, are conductive at least to some degree. Accordingly, while the term “non-conductive” may be used herein with regard to oil-based mud and similar drilling fluids, this use is merely indicative of electrical properties and not considered to be limiting of the teachings herein. Thus, it is recognized that a dielectric constant for the mud, εₘ, is generally variable. Therefore, as is the case in some of the embodiments provided herein, it may be desirable to characterize the dielectric constant for the mud, εₘ, downhole.

Embodiments of the present invention may analyze information and display information about formations. To that end, a processing system may be utilized. Referring to FIG. 1, there is shown an embodiment of a processing system 150 for implementing the teachings herein. In this embodiment, the system 150 has one or more central processing units (processors) 151a, 151b, 151c, etc. (collectively or generically referred to as processor(s) 151). In one embodiment, each processor 151 may include a reduced instruction set computer (RISC) microprocessor. Processors 151 are coupled to system memory 164 and various other components via a system bus 163. Read only memory (ROM) 152 is coupled to the system bus 163 and may include a basic input/output system (BIOS), which controls certain basic functions of system 150.

FIG. 1 further depicts an input/output (I/O) adapter 157 and a network adapter 156 coupled to the system bus 153. I/O adapter 157 may be a small computer system interface (SCSI) adapter that communicates with a hard disk 153 and/or tape storage drive 155 or any other similar component. I/O adapter 157, hard disk 153, and tape storage device 155 are collectively referred to herein as mass storage 154. A network adapter 156 interconnects bus 163 with an outside network 166 enabling data processing system 150 to communicate with other such systems. A screen (e.g., a display monitor) 165 is connected to system bus 163 by display adaptor 162, which may include a graphics adapter to improve the performance of graphics intensive applications and a video controller. In one embodiment, adapters 157, 156, and 152 may be connected to one or more I/O busses that are connected to system bus 153 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 163 via user interface adapter 158 and display adapter 162. A keyboard 159, mouse 160, and speaker 161 all interconnected to bus 163 via user interface adapter 158, which may include, for example, a Super I/O chip integrating multiple device adapters into a single integrated circuit.

Thus, as configured in FIG. 1, the system 150 includes processing means in the form of processors 151, storage means including system memory 164 and mass storage 154, input means such as keyboard 159 and mouse 160, and output means including speaker 161 and display 165. In one embodiment, a portion of system memory 164 and mass storage 154 collectively store an operating system.

It will be appreciated that the system 150 can be any suitable computer or computing platform, and may include a terminal, wireless device, information appliance, device, workstation, mini-computer, mainframe computer, personal digital assistant (PDA) or other computing device. It shall be understood that the system 150 may include multiple computing devices linked together by a communication network. For example, there may exist a client-server relationship between two systems and processing may be split between the two.

Examples of operating systems that may be supported by the system 100 include Windows 95, Windows 98, Windows NT 4.0, Windows XP, Windows 2000, Windows CE, Windows Vista, Mac OS, Java, AIX, LINUX, and UNIX, or any other suitable operating system. The system 150 also includes a network interface 106 for communicating over a network 166. The network 166 can be a local-area network (LAN), a metro-area network (MAN), or wide-area network (WAN), such as the Internet or World Wide Web.

Users of the system 150 can connect to the network through any suitable network interface 166 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 150 may machine-readable instructions stored on machine readable media (for example, the hard disk 154) for capture and interactive display of information shown on the screen 165 of a user.

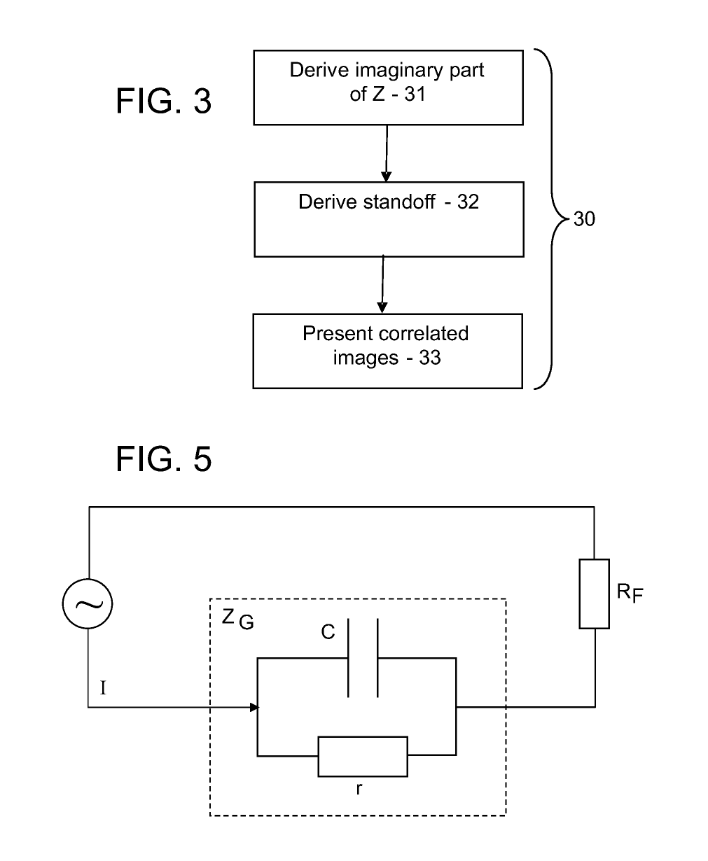

Now in greater detail, aspects of the invention are presented. As discussed above, imaging of a formation can be adversely affected by standoff and pad lift off (i.e., instances where the pad 3 does not firmly contact the wall of the wellbore 11). By combining imaginary and real parts of impedance data, two images may be generated. One image presents standoff information (i.e., generally a measurement of distance between the transmitting electrode 6 and the formation 10 of FIG. 1), while the other image presents information regarding resistivity of the formation resistivity. By presenting the two images, the user can better interpret and provide quality control of imaging results to make assessments regarding the formation resistivity. Accordingly, a method of the invention is presented in FIG. 3.

Referring to FIG. 3, in one embodiment, the invention includes a method for presenting dual images 30. In a first stage 31, the method for presenting dual images 30 calls for deriving both real and imaginary part of the impedance, Z, from impedance measurement data. This is discussed in greater detail below. In a second stage 32, the method for presenting dual images 30 calls for deriving associated standoff values, d, using imaginary part of the impedance, Zᵢ. This is also discussed in greater detail below. In a third stage 33, the method for presenting dual images 30 calls for correlating the standoff values, d, with respective resistivity image, derived from real part impedances. As techniques for correlating and providing graphic data are well known, this stage is not discussed in greater detail.

Turning now to the first stage 31 to derive the imaginary part of the impedance, Zᵢ, from resistivity measurement data, Eq. (1) may be used:

Zᵢ=Z_{Amp}·sin(φ) (1);

where Z_{Amp} represents an amplitude of the measured impedance, Z, and φ represents a phase of the measured impedance, Z.

Since the imaginary part of the impedance, Zᵢ, predominantly depends on the standoff, S, between the transmitter electrode 6 and the formation 10, the standoff, S, can be easily derived from the measurements (note that the imaginary part of the impedance, Zᵢ, is also represented by similar variables, such as Ż₂ further herein). As an example, since the capacitance, C, uniquely depends on the standoff, S, Eq. (2) may be used:

$$C = \frac{{ɛ}_{0} \cdot ɛ \cdot A}{S} ; \qquad ( 2 )$$

where A represents a square area of the transmitter electrode, S, represents the standoff (in millimeters), and ε₀ represents the dielectric constant in air (0.885*10-11 F/m) and εₘ represents the relative dielectric constant of the mud. Therefore, a measured imaginary part of impedance may be expressed as in Eq. (3):

$${Z}_{i} \approx \frac{1}{ω C} = \frac{d}{{ωɛ }_{m} {ɛ}_{0} A} ; \qquad ( 3 )$$

where ω represents the angular frequency (2·π·f)

Therefore, the standoff, S, may be derived using Eq. (4):

S=1000·ω·εₘ·ε₀A·Zᵢ=k·Zᵢ (4);

where k represents a constant portion of Eq. (4) equal to 1000ω·εₘε₀·A, if standoff S is measured in mm.

Therefore, as an example, consider the transmitter electrode 6 having a square area, A, of 0.96 E-4 m² (16 mm×6 mm) For current, I, having a frequency of 10 MHz and drilling mud with a dielectric constant, εₘ, of four (4), the constant, k, may be estimated as:

k=10³·2·3.14·10⁷·4·0.885·10⁻¹¹·0.96·10⁻⁴=21.34·10⁻⁵≈0.2·10⁻³

Exemplary results for the constant, k, are provided in Table 1.

| Current Frequency, f (MHz) | Constant, k |
|---|---|
| 10 | 0.2 × 10⁻³ |
| 24 | 0.48 × 10⁻³ |
| 40 | 0.8 × 10⁻³ |

Accordingly, with knowledge of the dielectric constant of the mud, εₘ, and the imaginary part of the impedance, Zᵢ, the standoff, S, can be estimated. Accordingly, having discussed obtaining the imaginary part of the impedance, Zᵢ, and the standoff, S, a remaining aspect to consider is estimation of the dielectric constant of the mud, εₘ.

Estimation of the dielectric constant of the mud, εₘ, may be performed in various ways. One technique is to use supplied values, such as would be provided by a provider of the drilling mud. Another technique is to perform measurements topside (e.g., such as in the pit), and calculate the dielectric constant of the mud, εₘ, from those measurements. A third technique is presented in U.S. patent application Ser. No. 11/748,696.

One technique for estimating the dielectric constant of the mud, εₘ, is disclosed in U.S. patent application Ser. No. 11/748,696, filed May 15, 2007, entitled “Dual Standoff Resistivity Imaging Instrument, Methods and Computer Program Products” by some of inventors of the technology in the present application. Application Ser. No. 11/748,696 is incorporated by reference herein in its entirety. Portions are also included herein for convenience of explanation.

In the application entitled “Dual Standoff Resistivity Imaging Instrument, Methods and Computer Program Products,” a sensor that includes offset electrodes is disclosed. As used therein, the terms “offset” and other similar terms make reference to a recess or protrusion of some dimension where a sensor electrode lies below (or above) a generally planar surface of the pad that includes the electrode. As is known in the art, “standoff” makes reference to a region between the sensor electrode and a wall of the borehole. For embodiments disclosed therein, it is further recognized that such terminology may be used to describe an electrode pad where a position of one sensor electrode has an offset that differs from the offset of another (second) sensor electrode. Stated another way, a sensor electrode may include an offset without being disposed in a borehole having a drilling fluid. When disposed in a borehole, the sensor electrodes having different offset dimensions will likewise have differing standoff values.

Using the dual offset sensor electrodes (e.g., at least two mutually offset electrodes), resistance of a formation can be calculated with only slight dependence on parasitic effects of standoff, variability of standoff, and variability of the mud electrical properties. The dual offset sensor electrodes can further be implemented to calculate resistivity of drilling mud as well as a dielectric constant of the drilling mud. These calculations may be performed independent of one another. It is appreciated that the systems and methods described herein can be implemented with operations including, but not limited to measurement-while-drilling (MWD), logging-while-drilling (LWD), logging-while-tripping (LWT), etc.

In an alternative embodiment, data from one image may be used to blank or mute parts of another image. In such an embodiment, rather than displaying two images proximate to one another, a single image may be displayed with portions muted. For example, in one embodiment a portion of a resistivity image may be muted when the standoff corresponding to those portions exceeds a preset amount.

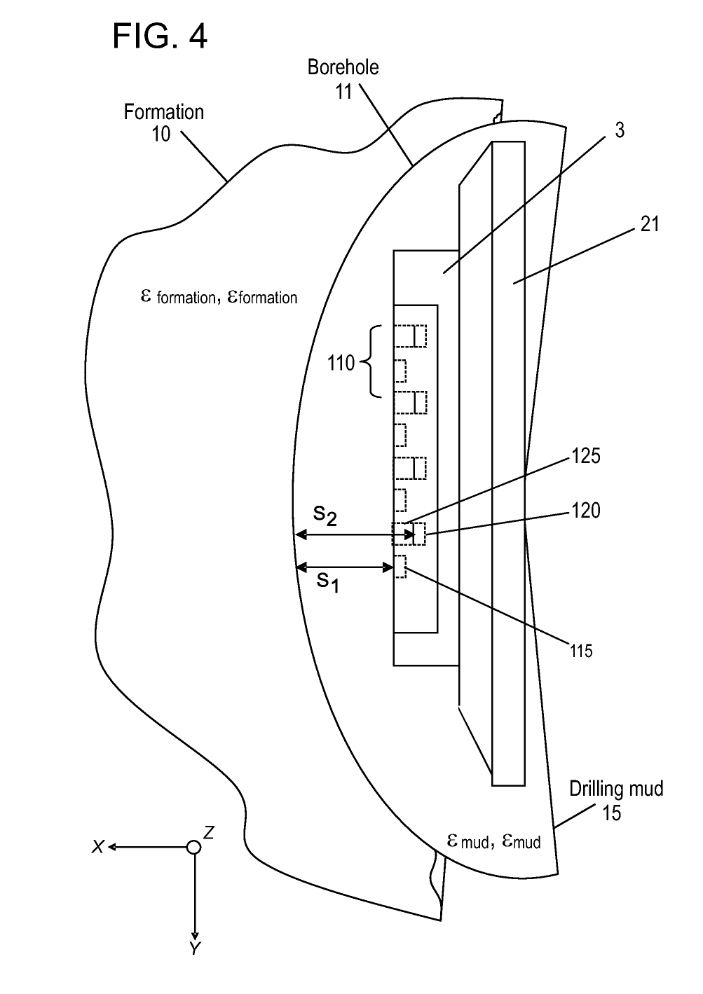

FIG. 4 illustrates a partial top side view of the exemplary pad 3 having dual standoff sensor electrode pairs 110. In this illustration, the imaging instrument 21 (partially shown) is suspended in the borehole 11 (partially shown). Furthermore, oil-based mud 15 is shown as disposed in the borehole 11 and further disposed within channels 125. The sensor electrodes may be considered to be either one of transmitter electrodes or return electrodes. In other embodiments, certain other functions and/or nomenclature may be applied to the sensor electrodes.

In an exemplary embodiment, when the instrument 21 is positioned in the desired location of the borehole 11 to obtain impedance measurements of the formation 10, two impedance measurements can be taken using a first sensor electrode 115 and a second sensor electrode 120. It is further appreciated that once the instrument 21 is in place at the vertical in the borehole 11, the first sensor electrode 115 and the second sensor electrode 120 are positioned at two different standoffs, S₁, S₂, with respect to the horizontal. As illustrated, the first sensor electrode 115 is positioned at standoff S₁ and the second, recessed, sensor electrode 120 is positioned at standoff S₂. In such an orientation, the resistivity of the formation ρ_{formation} (as well as the dielectric properties ε_{formation}) can be calculated as now described. It is further appreciated that with the exemplary methods described herein the electrical properties of the oil-based mud 15 (e.g., ρ_{mud}, ε_{mud}) disposed within the borehole 250 can also be calculated.

Accordingly, the pad 3 can be used to take complex impedance measurements within the borehole 11 via capacitive coupling between the first sensor electrode 115, the second sensor electrode 120 and the formation 10. Magnitudes and mutual phases of voltage drops and current flows are measured between the return electrode and each sensor electrode 115, 120 during respective measurements. As such, each sensor electrode 115, 120 may be used to inject current into the formation 10 and return measurements may be obtained in the return electrode. Commands for injection of current and respective measurements can be executed from an electronics module. Subsequent calculations of the electrical properties can be executed by use of support computing or processing capabilities.

FIG. 5 illustrates an exemplary equivalent schematic circuit diagram for one of the sensor electrodes 115, 120, and provides a review of problems associated with performing certain resistivity measurements. As represented in FIG. 5, the measured effective impedance Ż includes impedance of the gap (Ż_{G}) between the respective sensor electrode and the formation 10 wherein r and C are the equivalent resistance and capacitance component of the mud filling the gap and a resistance of the formation, R_{F}. Thus, if a voltage U is applied between the given sensor electrode 115, 120 and the return electrode, and İ represents the current measured, the impedance Ż may be written as Ż=Ż_{G}+R_{F}=U/İ. In the case of a low resistive formation 10 (i.e., ρ<10 ohm.m), the contribution of the formation 10 into the effective impedance Ż is small (|R_{F}|<<<|Ż_{G}|). This leads to reduction in sensitivity of the measured impedance Ż to the formation 10 resistivity, ρ_{formation}. The relatively large gap impedance Ż_{G} that depends on the mud properties is thus a major contributor into the measured total impedance. Accordingly, the teachings herein provide techniques for reduction such contributions to the measured total impedance, Ż.

According to an exemplary embodiment, in the dual standoff resistivity measurement, influence of the oil-based drilling mud 15 on formation resistivity image is effectively eliminated by taking two impedance measurements at two different standoff distances S₁, S₂. In an exemplary embodiment, two separate complex impedance measurements are taken using the first sensor electrode 115 and the second sensor electrode 120, which are disposed at respective standoffs S₁, S₂. As discussed above, the first sensor electrode 115 and the second sensor electrode 120 have common physical characteristics such as shape and area, A. The common characteristics provide for substantial elimination of variability arising from measurement circuit components. Refer again now to FIG. 4.

In FIG. 4, the first sensor electrode 115 is disposed at a first standoff distance, (or “standoff”) of S₁. The second sensor electrode 120 is disposed at a standoff distance of S₂. The standoff distance, S, represents a distance between a respective sensor electrode and a wall of the borehole 11. Not that position of the return electrode remains unchanged.

In general, the following relations hold: S₁/S₂=r₁/r₂=C₂/C₁ and r₁C₁=r₂C₂. As discussed above, r₁, r₂, C₁, C₂ are equivalent resistances and capacitances of the mud placed between sensor electrodes at two standoffs S₁, S₂.

The impedances measured by each of the sensor electrodes 115, 120 can be represented as:

$${\dot{Z}}_{1} = {R}_{F} + {\dot{Z}}_{G 1} where {\dot{Z}}_{G 1} = \frac{{r}_{1}}{1 + {( {r}_{1} {C}_{1} ω )}^{2}} - i \frac{{r}_{1}^{2} ω {C}_{1}}{1 + {( {r}_{1} {C}_{1} ω )}^{2}} , and$$

$${\dot{Z}}_{2} = {R}_{F} + {\dot{Z}}_{G 2} where {\dot{Z}}_{G 2} = \frac{{r}_{2}}{1 + {( {r}_{2} {C}_{2} ω )}^{2}} - i \frac{{r}_{2}^{2} ω {C}_{2}}{1 + {( {r}_{2} {C}_{2} ω )}^{2}}$$

where ω is the operational angular frequency of the instrument 10 signal. Given the relationship r₁C₁=r₂C₂, Ż_{G2} can be rewritten as:

$${Z}_{G 2} = \frac{{r}_{1}}{1 + {( {r}_{1} {C}_{1} ω )}^{2}} \frac{{C}_{1}}{{C}_{2}} - i \frac{{r}_{1}^{2} ω {C}_{1}}{1 + {( {r}_{1} {C}_{1} ω )}^{2}} \frac{{C}_{1}}{{C}_{2}}$$

Furthermore, for each standoff S₁, S₂, real and imaginary components of the complex impedances Ż and Ż measured by the sensor electrodes 115, 120 respectively, can be given by:

Ż₁=Ż_{G1}+R_{F}=A₁−iB₁

and

Ż₂=Ż_{G2}+R_{F}=A₂−iB₂.

As such, the real and imaginary components can be written as:

$${A}_{1} = \frac{{r}_{1}}{1 + {( {r}_{1} {C}_{1} ω )}^{2}} + {R}_{F} , {A}_{2} = \frac{{r}_{1}}{1 + {( {r}_{1} {C}_{1} ω )}^{2}} \frac{{C}_{1}}{{C}_{2}} + {R}_{F} and$$

$${B}_{1} = \frac{{r}_{1}^{2} ω {C}_{1}}{1 + {( {r}_{1} {C}_{1} ω )}^{2}} , {B}_{2} = \frac{{r}_{1}^{2} ω {C}_{1}}{1 + {( {r}_{1} {C}_{1} ω )}^{2}} \frac{{C}_{1}}{{C}_{2}}$$

From the above equation pairs of the real and imaginary components, the following relations are obtained:

$${A}_{2} - {A}_{1} = \frac{{r}_{1}}{1 + {( {r}_{1} {C}_{1} ω )}^{2}} ( \frac{{C}_{1}}{{C}_{2}} - 1 ) and$$

$$\frac{{B}_{2} - {B}_{1}}{ω} = \frac{{r}_{1} {r}_{1} {C}_{1}}{1 + {( {r}_{1} {C}_{1} ω )}^{2}} ( \frac{{C}_{1}}{{C}_{2}} - 1 ) .$$

From the above relationships, the parameter τ=r₁C₁ is obtained as:

$$τ = {r}_{1} {C}_{1} = \frac{1}{ω} \frac{{B}_{2} - {B}_{1}}{{A}_{2} - {A}_{1}}$$

Using the known relationship of the real and imaginary components B₂-B₁ and A₂-A₁, the value of r₁ is calculated as:

$${r}_{1} = \frac{{B}_{1} ( 1 + {( τω )}^{2} )}{τω}$$

Therefore, the resistance of the formation, R_{F}, can be calculated as follows:

$${R}_{F} = {A}_{1} - \frac{{r}_{1}}{1 + {( τω )}^{2}} .$$

It is therefore, appreciated that by obtaining two different impedance measurements Ż₁ and Ż₂ at the corresponding standoff S₁, and S₂, contribution of the gap impedance is eliminated, and values A₁, r₁, τ, ω are used to calculate the impedance of the formation 10. Therefore, by representing the gap impedances only by known properties of the sensor electrodes 115, 120, a calculation for the resistance of the formation, R_{F}, can be obtained with all measured values. Thus, the parasitic impact of the electrical properties for the drilling mud 15 is eliminated. Similarly, the values of C₁, r₂, and C₂ can be calculated. Furthermore, with the known area, A, of the sensor electrodes 115, 120, properties of the drilling mud 15 can also be calculated. For the two standoffs S₁, S₂, the parameter Δ is defined as Δ=S₂-S₂, such that, r₂-r₁=ρ_{mud}Δ/A, where ρ_{mud} can be determined as ρ_{mud}=(r₂−r₁) A/Δ. Similarly the dielectric constant of the mud 15 can be determined as ε_{mud}=(C₂−C₁) A/Δ.

Note that as disclosed herein, formation dielectric properties are generally neglected for the sake of clarity and simplicity. To take into consideration dielectric properties of the formation one would need to perform extra measurements using a different frequency. Then, using dual frequency and dual standoff data, both resistivity and dielectric constant of the formation can be derived.

In other exemplary embodiments, a dual standoff arrangement can be achieved with other structural arrangements. For example, the first sensor electrode 115 can be flush with the insulator 130 as discussed above. The second sensor electrode 120 can be disposed on the surface 131 of the insulator 130, which still results in an arrangement having a distance differential between the first sensor electrode 115 and the second sensor electrode 120. In still another exemplary embodiment, a single retractable sensor electrode (not shown) can be disposed on the pad 100 within the insulator 130. As such, a first set of measurements can be taken with the retractable sensor electrode positioned at a first standoff from the borehole wall. A second set of measurements can then be taken with the retractable sensor electrodes positioned at a second standoff from the borehole wall. The two sets of measurements can then be used to calculate the resistivities as described herein.

In other exemplary embodiments, formation dielectric properties can also be calculated with the methods and systems described herein. To take into consideration dielectric properties of the formation, extra measurements can be taken under the same conditions as described herein. However, a different frequency ω from the operational frequency as discussed above can be implemented. As such, using a set of dual frequencies and dual standoff data, both resistivity and dielectric constant of the formation can be derived.

Regardless of the desired electrical properties to be measured, and further regardless of the structural arrangement of the dual standoff sensor electrodes 115, 120, it is appreciated that implementing the dual standoff (i.e., offset) arrangement allows the formation electrical properties to be measured by removing parasitic impact of oil-based drilling mud 15.

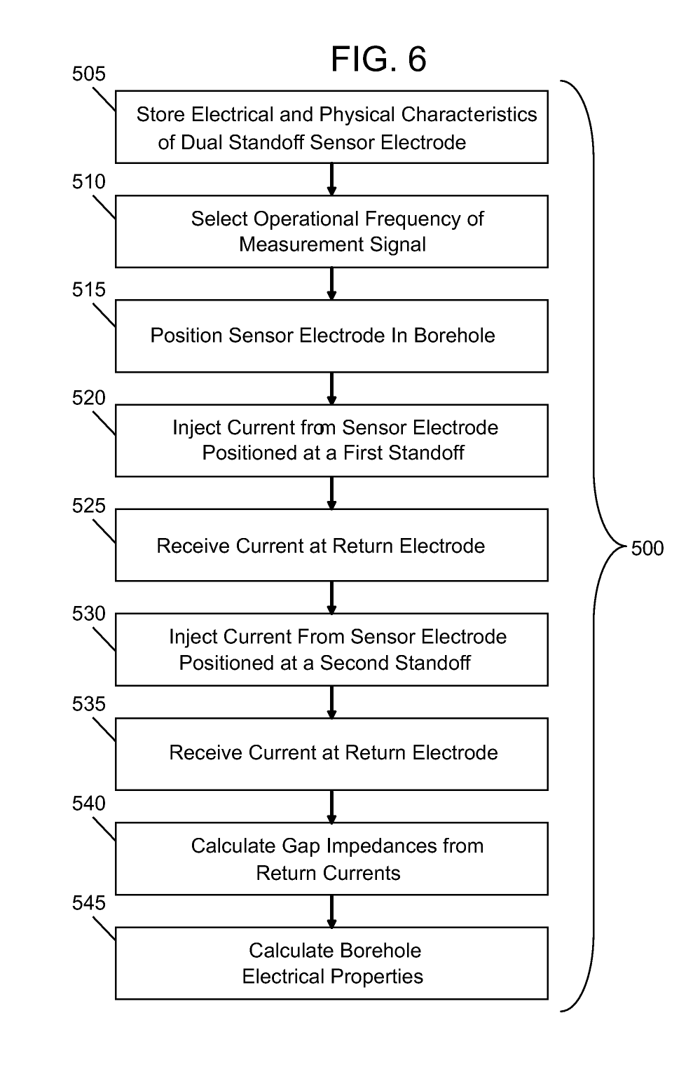

FIG. 6 illustrates an exemplary impedance measurement and calculation method 500 implementing dual standoff arrangements. At step 505, the known electrical and physical characteristics of the sensor electrodes used in the measurements are stored in the computer. In the exemplary embodiments described herein, the known physical characteristics (e.g., the area, A) of the sensor electrodes 115, 120 can be stored in the computer 24. At step 510, the operational frequency ω of the instrument 21 is selected. At step 515, the instrument 21 is positioned in the borehole 12 at the position in which desired electrical properties of the formation 10 are to be measured. It is appreciated that steps 505-515 can be performed simultaneously, at distinct intervals or in an alternative order.

At step 520, current from the sensor electrode is injected into the formation 10 at a first standoff S₁. At step 525, the return current is measured. Similarly, at step 530 current from the sensor electrode is injected into the formation 13 at a second standoff S₂ and the return current is measured at step 535. As discussed above, the two different current injections and return current measurements are implemented via the sensor electrodes 115, 120 disposed at the two fixed dual standoffs S₁, S₂. In other exemplary embodiments, a single sensor electrode can be adjustable such that the single sensor electrode can be positioned at the two different standoffs S₁, S₂ to make the measurements as described.

At step 540, the gap impedances Ż_{G} can be calculated as described above. From the gap impedance measurements, and the known electrical and physical characteristics of the sensor electrodes used in the measurements, the electrical characteristics of the borehole 11 can be calculated at step 545. As described above, the electrical characteristics of both the formation 10 and the drilling mud 15 can be calculated from the known electrical and physical characteristics of the sensor electrode and the operational frequencies of the instrument 21.

Having thus described calculating the dielectric constant for the mud, εₘ, a remaining stage of the method for presenting dual images 30 (presented in FIG. 3) simply calls for coordinating and associating data and then presenting the data graphically.

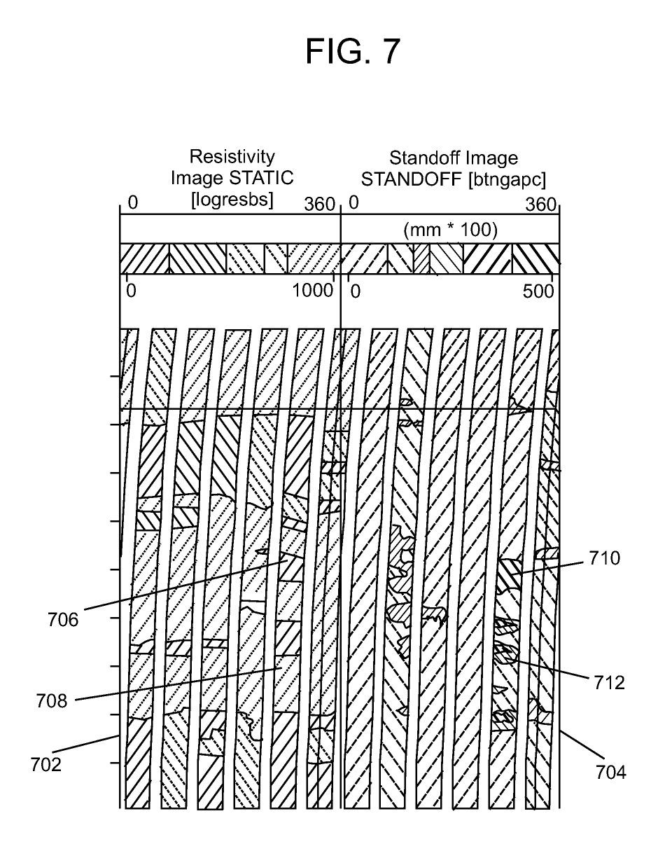

Referring to FIG. 7, an example of dual image results is shown. In this example, two images are presented. The first image 702 is produced using the real part of impedance measurement data, while the second image 704 is produced using the imaginary part of the measured impedances. In this embodiment, the first image 702 is displayed at the same time and on the same display as the second image 704. In one embodiment, the first image 702 is displayed proximate to the second image 704. That is, the first image 702 and the second image 704 need not be displayed directly next to one another but, rather, need only be displayed such that both may be viewed at the same time on the same screen. In this illustration, the first image 702 may be referred to as resistivity image and the second image 704 as the standoff image. In this illustration, the imaginary part of the measured impedances were converted into the standoff image 704 presented according to the technique described above. By looking into the standoff image 704, it may be concluded that some features of resistivity image should not be interpreted as being representative of the formation, but rather positioning of the pad with respect to the borehole. When the graphic images are shown in color, the information provided to users is rich and meaningful. In the illustration, a first portion 706 of the resistivity image 702 may be disregarded based on standoff image portion 710 and a second portion 708 of the resistivity image 702 may be disregarded based on standoff image 710.

As one can surmise, the data in the first image 702 is associated with the data presented in the second image 704. That is, the data in the images may be correlated by at least one of depth, sensor identification and the like.

It shall be understood that rather than showing two separate images, portions of the resitivity image may be muted or otherwise rendered unreadable in the event a corresponding standoff exceeds a particular threshold. Thus, in the illustration, the standoff image 704 may be omitted and portions 706 and 708 of the resitivity image 702 muted in one embodiment.

In some embodiments, a computer program product is provided that includes aspects such as a user interface. Aside from receiving input for directing output to at least one of a display screen, a printer, a plotter, and the like, the interface may let users select or parse certain information. For example, the computer program product may enable the user to expand an area of interest (i.e., “zoom in”), collapse data (i.e., “zoom out”), and further may permit users to display data from multiple wellbores 11, such as on one screen (such that comparative analyses of wells may be performed). In addition, users may input data, such as the relative dielectric constant of the mud, εₘ, in support of the teachings herein, and also such that various “what if” scenarios may be explored and the like.

In support of the teachings herein, various analysis components may be used, including digital and/or an analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement methods of the present invention. These instructions may provide for equipment operation, control, data collection and analysis and other functions deemed relevant by a system designer, owner, user or other such personnel, in addition to the functions described in this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed. Examples include various other components that may be called upon for providing for aspects of the teachings herein, such as: a sample line, sample storage, sample chamber, sample exhaust, pump, piston, power supply (e.g., at least one of a generator, a remote supply and a battery), vacuum supply, pressure supply, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for presenting a formation property to a user comprising:
estimating an initial property of the formation using a tool conveyed in a borehole;
estimating a relationship between the tool and the formation based on information received from the tool;
presenting the user a first output based at least in part on the initial property; and
presenting a second output based at least in part on the relationship proximate the first output.

2. The method of claim 1, wherein the initial property includes a formation resistivity.

3. The method of claim 1, wherein the relationship includes a standoff between the tool and the formation.

4. The method of claim 3, wherein the standoff is based at least in part on the initial property.

5. The method of claim 2, wherein the first output is based on a real part of the resitivity.

6. The method of claim 2, wherein the relationship is based on the initial property and represents a standoff between the tool and the formation.

7. The method of claim 6, wherein the standoff based at least in part on an imaginary part of the resistivity.

8. A computer program product for presenting two or more images of sub-surface materials, the computer program product comprising:
a storage medium readable by a processing circuit and storing instructions for execution by the processing circuit for facilitating a method including:
estimating an initial property of the formation using a tool conveyed in a borehole;
estimating a relationship between the tool and the formation based on information received from the tool;
presenting the user a first output based at least in part on the initial property; and
presenting a second output based at least in part on the relationship proximate the first output.

9. The computer program product as in claim 8, wherein presenting a first output and presenting a second output includes at least one of outputting to a display and a printer.

10. The computer program product as in claim 8, further comprising: providing a user interface for controlling a graphic output.

11. The computer program product as in claim 10, wherein the user interface permits at least one of: zooming in, zooming out, and selecting at least one additional well for output.

12. The computer program product as in claim 10, wherein the user interface permits input of at least one variable.

13. A system for presenting a formation property to a user, the system comprising:
a processor that receives information from a tool conveyed in a borehole proximate the earth formation, the processor estimating an initial property of the formation and estimating a relationship between the tool and the formation based on information received from the tool; and
a graphical user interface in cooperation with the processor that displays a first output based on the initial property and a second output based on the relationship, the second output being displayed proximate the first output.

14. The system of claim 13, wherein the initial property includes a formation resistivity.

15. The system of claim 13, wherein the relationship includes a standoff between the tool and the formation.

16. The system of claim 15, wherein the standoff is based at least in part on the initial property.

17. The system of claim 13, wherein the initial property includes a resitivity of the formation and wherein the first output is based at least in part on a real part of the resitivity.

18. The system of claim 17, wherein the relationship is based on the initial property and represents a standoff between the tool and the formation.

19. The system of claim 18, wherein the standoff is based at least in part on an imaginary part of the resistivity.

20. A method for presenting a formation property to a user comprising:
estimating an initial property of the formation using a tool conveyed in a borehole;
estimating a relationship between the tool and the formation based on information received from the tool; and
presenting the user a first output based on the initial property and the relationship, the portion of the first output based on the initial property being muted when the relationship exceeds a preset amount.

21. The method of claim 20, wherein the initial property includes a formation resistivity.

22. The method of claim 20, wherein the relationship includes a standoff between the tool and the formation.
